(19) United States
(12) Patent Application Publication
(10) Pub. No.: US 2011/0051026 A1
(43) Pub. Date: Mar. 3, 2011

(54) PHOTO-ALIGNMENT AGENT AND LIQUID CRYSTAL DISPLAY DEVICE USING THE SAME

(76) Inventors: Tae-Ho Kim, Seoul (KR); Jun-Woo Lee, Anyang-si (KR); Baek-Kyun Jeon, Yongin-si (KR); Suk-Hoon Kang, Seoul (KR); Soo-Ryun Cho, Gunpo-si (KR)

(21) Appl. No.: 12/818,089

(22) Filed: Jun. 17, 2010

(30) Foreign Application Priority Data
Aug. 26, 2009 (KR) 10-2009-0079469

(51) Int. Cl. G02F 1/136; C09K 19/56; G02F 1/1337

(52) U.S. Cl. 349/42; 252/299.4; 428/1.2; 349/123

(57) ABSTRACT

A photo-alignment agent and a liquid crystal display using the same are provided. A photo-reactive group according to an exemplary embodiment of the present invention includes a first alignment material without a photo-reactive group, a second alignment material including a photo-reactive group, and a photosensitizer mixed with the second alignment material.

### CROSS-REFERENCE TO RELATED APPLICATION

This application claims priority to and the benefit of Korean Patent Application No. 10-2009-0079469 filed in the Korean Intellectual Property Office on Aug. 26, 2009, the entire contents of which are incorporated herein by reference.

### BACKGROUND OF THE INVENTION

(a) Field of the Invention

The present invention relates to a photo-alignment agent and a liquid crystal display using the same.

(b) Description of the Related Art

One of the most widely used flat panel displays, a liquid crystal display (LCD) includes two display panels, each provided with field generating electrodes such as pixel electrodes and a common electrode, and a liquid crystal (LC) layer interposed therebetween. The LCD displays images by applying voltages to the field-generating electrodes on the display panel to generate an electric field across the LC layer. The electric field across the LC layer determines the orientation of LC molecules therein to adjust the polarization of incident light.

In the liquid crystal layer, an alignment layer is formed on the inner surfaces of the two display panels. The alignment layer aligns the liquid crystal molecules of the liquid crystal layer. If no voltage is applied to the field generating electrodes, the alignment layer aligns the liquid crystal molecules of the liquid crystal layer in a predetermined direction, while with the application of a voltage to the field generating electrodes, the liquid crystal molecules of the liquid crystal layer are rotated in the direction of the electric field.

In a conventional method for forming an alignment layer to align the liquid crystal, a rubbing method is used. In the rubbing method, a polymer layer, such as polyamide, is coated on a substrate such as glass, and the surface thereof is rubbed in a predetermined direction by using a fiber such as nylon or polyester. However, the rubbing method may generate minute dust and an electrostatic discharge (ESD), because of the friction between the fiber material and the polymer layer. The resulting dust and ESD may generate serious problems when manufacturing the liquid crystal panel.

To solve this problem, a light alignment method in which anisotropy is induced to the polymer layer, thus aligning the liquid crystal, has recently been researched.

The above information disclosed in this Background section is only for enhancement of understanding of the background of the invention and therefore it may contain information that does not form the prior art that is already known in this country to a person of ordinary skill in the art.

### SUMMARY OF THE INVENTION

In one aspect, photo-reaction efficiency of a photo-alignment layer to improve transmittance is increased.

A photo-alignment agent according to the present invention includes a first alignment material without a photo-reactive group, a second alignment material including a photo-reactive group, and a photosensitizer mixed with the second alignment material.

The photosensitizer may be an additional material that does not chemically reacted with the second alignment material.

The photosensitizer may be one of compounds represented by Formula 1 to Formula 3.

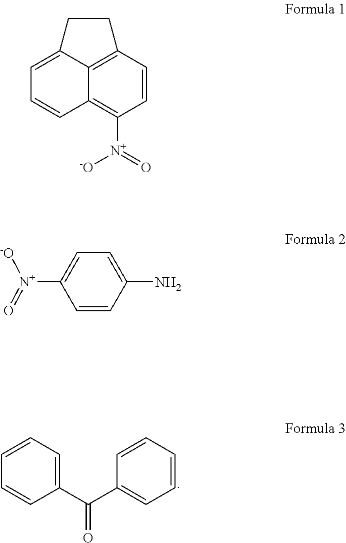

The photosensitizer may be coupled to the second alignment material after baking the second alignment material.

The photosensitizer may include a functional group capable of reacting with the second alignment material.

The functional group may be one of an epoxy group, an amine group, a carboxylic acid group, and an alcohol group.

The photosensitizer may be one of compounds represented by Formula 4 and Formula 5.

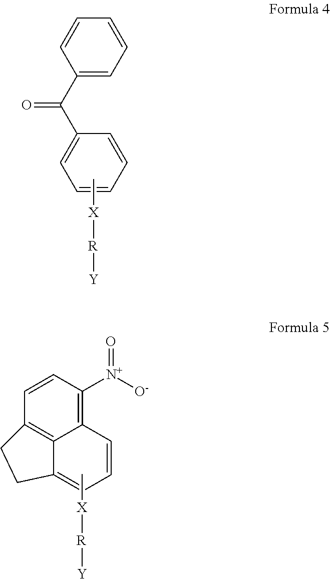

Herein, X as a coupler may represent —O— or —S—, R may represent an alkyl having 1-15 carbon atoms, and Y may represent an oxirane, —OH, —NH₂, or —COOH.

The photo-alignment layer may be formed by copolymerizing a first monomer including the photosensitizer and a second monomer including the photo-reactive group.

The first monomer may be one of compounds represented by Formula 6 and Formula 7.

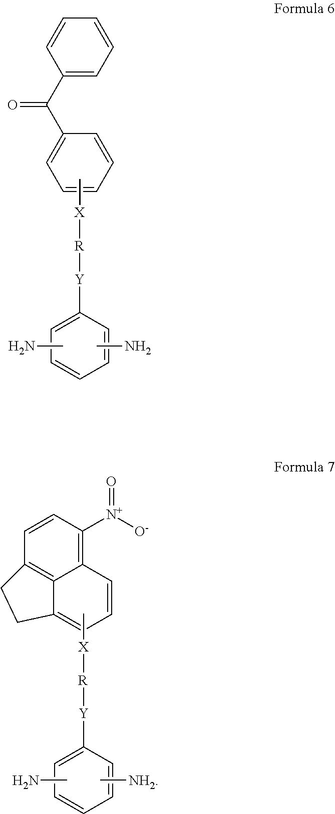

Herein, X as a coupler may represent —O— or —S—, R may represent an alkyl having 1-15 carbon atoms, and Y may represent —O— or —COO—.

The photosensitizer may absorb a wavelength of 200-500 μm from a UV light source that is linearly polarized, thereby transmitting energy to the photo-reactive group.

The first alignment material and the second alignment material may form the alignment layer, and a ratio of a mol concentration of the second alignment material to a mol concentration of the first alignment material may be increased close to the surface of the alignment layer.

The first alignment material and the second alignment material may have a weight ratio of 5:95 to 50:50.

The second alignment material may include an imide group at a concentration of more than 75 mol %.

A photo-alignment agent according to the present invention includes a photo-alignment material that includes a main chain and a side chain having a photo-reactive group, and a photosensitizer, wherein the photo-reactive group includes a compound represented by Formula A.

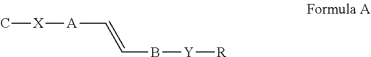

Herein, A and B are independently one of cyclohexane, —CH₂—, —C₂H₄—, dioxane, tetrahydropyran, benzene, naphthalene, and chromane, X and Y are independently single bonds or —CₙH₂ₙ—, where n is an integer of 1 to 12, and R is hydrogen or an alkyl group with 1 to 12 carbon atoms.

The C in the compound represented by Formula A may be one of compounds represented by Formula 10 to 13.

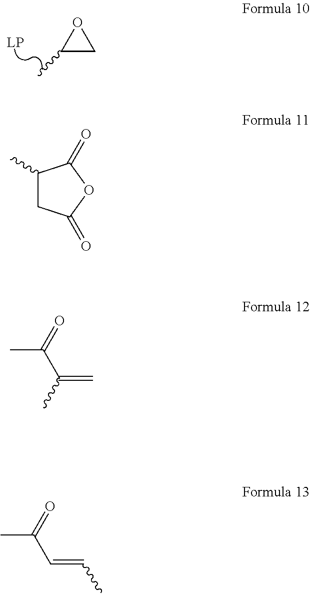

Herein, LP is a position connected to X.

The photosensitizer may be an additional material that does not react with the main chain or the photo-reactive group, and may be one of compounds represented by Formula 1 to Formula 3.

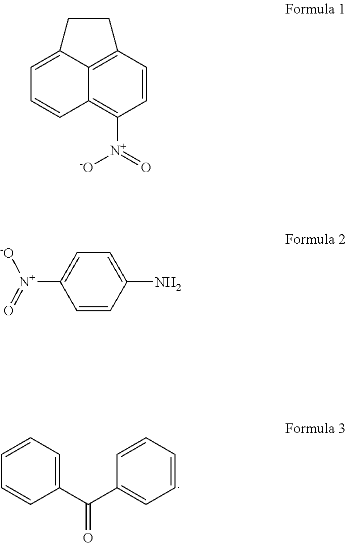

The photosensitizer may include a functional group coupled with the main chain after baking the second alignment material, and the functional group is one of an epoxy group, an amine group, a carboxylic acid group, and an alcohol group.

The photo-alignment layer may be formed by copolymerizing a first monomer including the photosensitizer and a second monomer including the photo-reactive group.

A liquid crystal display according to the present invention includes: a first substrate; a second substrate facing the first substrate; an alignment layer formed on at least one of the first substrate and the second substrate, the alignment layer including a first alignment material, a second alignment material including a photo-reactive group, and a photosensitizer mixed with the second alignment material; and a liquid crystal layer interposed between the first substrate and the second substrate.

The photosensitizer may absorb a wavelength of 200-500 μm from a UV light source that is linearly polarized, thereby transmitting energy to the photo-reactive group.

The photo-reactive group may include a compound represented by Formula A.

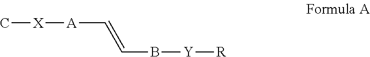

Herein, A and B are independently one of cyclohexane, —CH2-, —C2H4-, dioxane, tetrahydropyran, benzene, naphthalene, and chromane, X and Y are independently single bonds or —CnH2n-, and n is an integer of 1 to 12.

The photosensitizer may be an additional material that is not reacted with the second alignment material, and is one of compounds represented by Formula 1 to Formula 3.

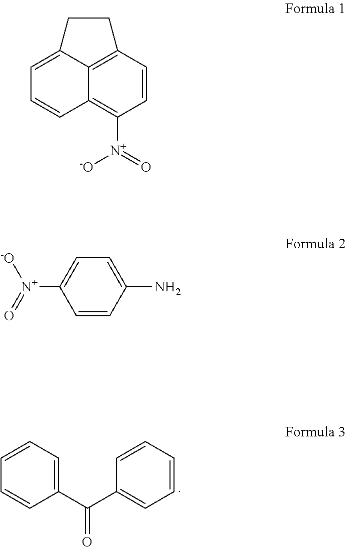

The photosensitizer may include a functional group coupled with the main chain after baking the photo-alignment material, and the functional group may be one of an epoxy group, an amine group, a carboxylic acid group, and an alcohol group.

The alignment layer may be formed by copolymerizing a first monomer including the photosensitizer and a second monomer including the photo-reactive group.

A ratio of a mol concentration of the second alignment material to a mol concentration of the first alignment material may be increased close to the surface of the alignment layer.

The liquid crystal display may further include: a first signal line and a second signal line intersecting each other on the first substrate; a thin film transistor connected to the first signal line and the second signal line; a pixel electrode connected to the thin film transistor; and a common electrode formed on the second substrate.

The pixel electrode may include a first sub-pixel electrode and a second sub-pixel electrode.

The second sub-pixel electrode may include a first electrode piece disposed, in a layout view, above the first sub-pixel electrode, a second electrode piece disposed, in a layout view, under the first sub-pixel electrode and connected to the first sub-pixel electrode, and a plurality of bridge sections connecting the first electrode piece and the second electrode on, in a layout view, right and left sides of the first sub-pixel electrode.

As described above, according to the present invention, the pre-tilt angle is increased such that the transmittance may be improved.

### BRIEF DESCRIPTION OF THE DRAWINGS

FIG. 1 is an equivalent circuit diagram of a pixel in a liquid crystal display according to an exemplary embodiment.

FIG. 2 is a layout view of a pixel electrode in a liquid crystal display according to an exemplary embodiment.

FIG. 3 is a schematic cross-sectional view of a liquid crystal display with the pixel electrode shown in FIG. 2 taken along the III-III line thereof.

FIG. 4 is a layout view of a liquid crystal display according to an exemplary embodiment.

FIG. 5 is a layout view of a storage electrode line of the liquid crystal display shown in FIG. 4.

FIG. 6 is a layout view of the liquid crystal display shown in FIG. 4 illustrating the directions that the aligned liquid crystal molecules are oriented over different regions on a pixel electrode thereof.

FIG. 7 is a cross-sectional view of the liquid crystal display shown in FIG. 4 taken along the VII-VII line thereof.

FIG. 8 is a conceptual view of an alignment layer according to an exemplary embodiment.

FIG. 9 is a conceptual view of an alignment layer according to another exemplary embodiment.

FIG. 10 is a conceptual view of an alignment layer according to another exemplary embodiment.

FIG. 11 is a graph illustrating results of an analysis of an alignment layer according to an exemplary embodiment using a TOF-SIMS technique.

FIG. 12 is a graph illustrating results of an analysis of an alignment layer according to an exemplary embodiment using a TOF-SIMS technique.

FIG. 13 is a graph illustrating spot and afterimage degrees of a liquid crystal display with an alignment layer according to an exemplary embodiment.

FIG. 14 is a graph illustrating the afterimage degree of a liquid crystal display with an alignment layer according to an exemplary embodiment.

FIG. 15 is a graph illustrating a pre-tilt degree according to addition of a photosensitizer according to an exemplary embodiment.

FIG. 16 is a pixel picture of a photo-aligned cell including 4-direction domains.

FIG. 17 is a graph showing transmittance according to a pre-tilt degree.

FIG. 18 is a graph showing voltage holding ratio and ion density for a content of a photosensitizer according to an exemplary embodiment.

### DESCRIPTION OF REFERENCE NUMERALS INDICATING PRIMARY ELEMENTS IN THE DRAWINGS

| | |
|---|---|
| 3 liquid crystal layer | 11, 21 alignment layer |
| 16 photo-reactive group | 17, 18 main chain |
| 40 photosensitizer | 110, 210 substrate |
| 191 pixel electrode | 270 common electrode |
| X vertical photo-alignment material | Y alignment material |

### DETAILED DESCRIPTION OF THE EMBODIMENTS

The present invention will be described more fully hereinafter with reference to the accompanying drawings, in which exemplary embodiments are shown. However, the present invention is not limited to exemplary embodiments described herein, and may be embodied in other forms. Rather, exemplary embodiments described herein are provided to describe the disclosed contents and to explain the ideas of the disclosure to a person of ordinary skill in the art.

In the drawings, the thicknesses of layers and regions are exaggerated for clarity. It is to be noted that when a layer is referred to as being “on” another layer or substrate, it can be directly formed on the other layer or substrate or it can be formed on the other layer or substrate with a third layer interposed therebetween. Like constituent elements are denoted by like reference numerals throughout the specification.

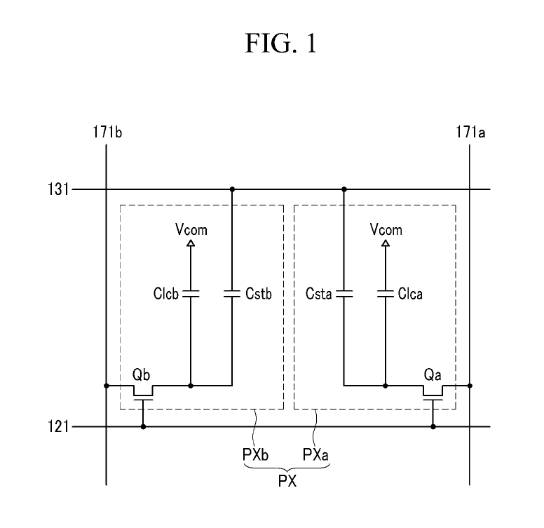

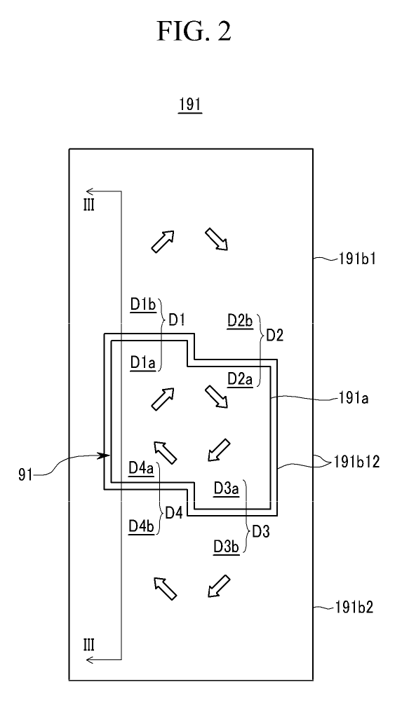

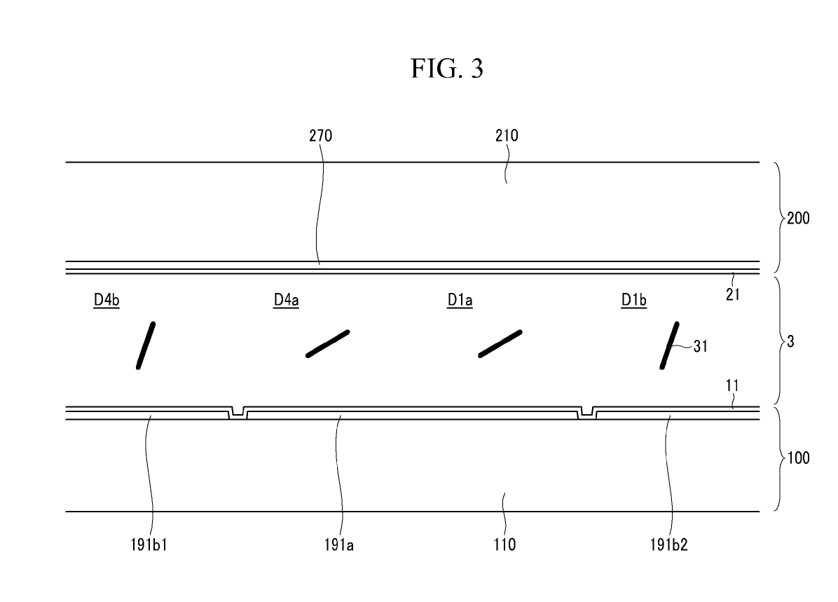

FIG. 1 is an equivalent circuit diagram of a pixel in a liquid crystal display according to an exemplary embodiment, FIG. 2 is a layout view of a pixel electrode in a liquid crystal display according to an exemplary embodiment, and FIG. 3 is a schematic cross-sectional view of a liquid crystal display with the pixel electrode shown in FIG. 2 taken along the III-III line thereof.

Referring to FIG. 1, a liquid crystal display according to an exemplary embodiment includes a plurality of signal lines 121, 131, 171a, and 171b, and pixels PX connected thereto.

Referring to FIG. 2 and FIG. 3, the liquid crystal display according to the present exemplary embodiment includes lower and upper display panels 100 and 200, respectively, facing each other, and a liquid crystal layer 3 interposed between the two panels 100 and 200. Pixel electrodes 191 (which includes 191a, 191b1, and 191b2) are formed on the lower display panel 100, and a common electrode 270 is formed on the upper display panel 200.

Alignment layers 11 and 21 are formed on the pixel and common electrodes 191 and 270, respectively. A detailed description of the alignment layers 11 and 21 will be provided below.

The pixel electrode 191 includes first and second sub-pixel electrodes 191a and 191b that are separated from each other.

The signal lines 121, 131, 171a, and 171b are formed on the lower panel 100, and include gate lines 121 for transmitting gate signals, a pair of data lines 171a and 171b for transmitting data voltages, and storage electrode lines 131, to which storage voltages are applied.

The pixels PX each include a pair of sub-pixels PXa and PXb, each of which includes switching elements Qa and Qb, liquid crystal capacitors Clca and Clcb, and storage capacitors Csta and Cstb.

The switching elements Qa and Qb are three-terminal elements that include gate, source, and drain electrodes, and which are formed on the lower panel 100. The gate electrode of the switching elements Qa and Qb is connected to the gate line 121, the source electrode thereof is connected to the data lines 171a and 171b, and the drain electrode thereof is connected to the liquid crystal capacitors Clca and Clcb and the storage capacitors Csta and Cstb.

The liquid crystal capacitors Clca and Clcb are composed of the sub-pixel electrodes 191a and 191b of the lower display panel 100 and the common electrode 270 of the upper display panel 200, which act as the two capacitor terminals, and the liquid crystal layer 3, which acts as a dielectric, interposed between the two capacitor terminals, 191a and 191 band 270. The sub-pixel electrodes 191a and 191b are connected to the switching elements Qa and Qb, and the common electrode 270 is formed on the entire surface of the upper display panel 200 so as to receive a common voltage Vcom.

The storage capacitors Csta and Cstb, which serve to assist the liquid crystal capacitors Clca and Clcb, are formed by interposing an insulator between the overlapped storage electrode line 131 and pixel electrodes 191a and 191b. The storage capacitors Csta and Cstb may be omitted as needed.

Referring to FIG. 2, the pixel electrode 191 is formed in the shape of a rectangle elongated in the vertical direction, and the first sub-pixel electrode 191a thereof is surrounded by the second sub-pixel electrode 191b thereof.

The first sub-pixel electrode 191a is shaped such that two identical rectangles, that are elongated in the vertical direction, are eccentrically (i.e., with offset centers) attached to each other in the horizontal direction along of the longer sides of each rectangle. Typically, the two identical rectangles are attached to each other so that their centers are offset by the amount required for the central, attached section of the rectangles, not including the protruding portions, to form a square. However, the length ratio of the horizontal side to the vertical side of the first sub-pixel electrode 191a may be altered in other ways.

The second sub-pixel electrode 191b surrounds the first sub-pixel electrode 191a with a gap 91, which has an approximately uniform width. The sub-pixel electrode 191b includes an upper electrode portion 191b1 formed over the first sub-pixel electrode 191a, a lower electrode portion 191b2 formed below the first sub-pixel electrode 191a, and bridge portions 191b12 interconnecting the upper and lower electrode portions 191b1 and 191b2 on the left and right sides of the first sub-pixel electrode 191a.

The second sub-pixel electrode 191b is greater in size than the first sub-pixel electrode 191a, and it is possible to control the length ratio of the vertical side of the first sub-pixel electrode 191a to the vertical side of the second sub-pixel electrode 191b to obtain a desired area ratio thereof. For example, the area of the second sub-pixel electrode 191b may be approximately two times the area of the first sub-pixel electrode 191a. In this case, the first sub-pixel electrode 191a, the upper electrode portion 191b1, and the lower electrode portion 191b2 may all have the same area.

The liquid crystal layer 3 has negative dielectric anisotropy, and liquid crystal molecules thereof are vertically aligned. Polarizers (not shown) may be attached to the outer surfaces of substrates 110 and 210, respectively. The polarization axes of the polarizers may be perpendicular to each other while being inclined with respect to the horizontal and vertical directions by about 45 degrees.

When there is no electric field generated at the liquid crystal layer 3, that is, when there is no voltage difference between the pixel and common electrodes 191 and 270, liquid crystal molecules 31 may be oriented perpendicular to the surface of the alignment layers 11 and 21, or may be slightly inclined with respect thereto.

When a potential difference is applied between the pixel and common electrodes 191 and 270, an electric field substantially perpendicular to the surface of the display panels 100 and 200 is generated across the liquid crystal layer 3. Hereinafter, the pixel electrode 191 and the common electrode 270 will be collectively referred to as the “field generating electrodes.” The liquid crystal molecules 31 of the liquid crystal layer 3 rotate in response to the electric field such that the directors (i.e., the average orientation axes along the molecules, which is in the direction of the preferred orientation) thereof are oriented toward the direction perpendicular to the direction of the electric field. The degree of polarization of the light incident upon the liquid crystal layer 3 varies depending upon the degree of inclination of the liquid crystal molecules 31. The variation in polarization is expressed by a variation in light transmittance through the polarizers so that the liquid crystal display can display images.

The direction that the liquid crystal molecules 31 are oriented depends upon the characteristics of the alignment layers 11 and 21. For example, the direction the liquid crystal molecules 31 are oriented may be determined by, when forming the alignment layer, irradiating the alignment layers 11 and 21 with ultraviolet rays that differ in polarization direction to, or irradiating them in a slanted manner.

The liquid crystal molecules 31 of the liquid crystal layer 3 that are aligned over the pixel electrode 191 can have different orientation directions on different regions of the pixel electrode. The pixel electrode 191 may, for example, be partitioned into four regions: a left upper region D1; a right upper region D2; a right lower region D3; and a left lower region D4. The partitioned regions D1 to D4 have substantially the same size and are adjacent to each other in the horizontal and vertical directions, with the horizontal and vertical center lines of the pixel electrode 191 forming the boundaries between regions. Typically, the orientation directions of the liquid crystal molecules placed in the regions D1 to D4 are angled with respect to each other by about 90 degrees, and the inclination directions of the liquid crystal molecules adjacent to each other are oriented in diagonally opposite directions.

The arrows in FIG. 2 indicate the orientation directions of the liquid crystal molecules 31, which are oriented at the left upper region D1 to be in the right upper direction, at the right upper region D2 to be in the right lower direction, at the right lower region D3 to be in the left lower direction, and at the left lower region D4 to be in the left upper direction.

However, the directions the liquid crystal molecules 31 are oriented in the four regions D1 to D4 are not limited to the above, and may be altered in various manners. Furthermore, the number of different directions the liquid crystal molecules 31 are oriented may be more or less than four. When the directions the liquid crystal molecules are oriented are diversified, the reference viewing angle of the liquid crystal display is increased.

Different voltages are applied to the first and second sub-pixel electrodes 191a and 191b, and based on the magnitude of the common voltage Vcom, the relative voltage of the first sub-pixel electrode 191a is generally higher than the relative voltage of the second sub-pixel electrode 191b. The inclination angle of the liquid crystal molecules is differentiated depending upon the intensity of the electric field. When the voltages of the first and second sub-pixel electrodes 191a and 191b are different from each other, the liquid crystal molecules 31 placed over the two sub-pixel electrodes 191a and 191b will have different inclination angles from each other.

Accordingly, the respective regions D1 to D4 of the liquid crystal layer 3 are divided into first sub-regions D1a, D2a, D3a, and D4a over the first sub-pixel electrode 191a, and second sub-regions D1b, D2b, D3b, and D4b over the second sub-pixel electrode 191b. As shown in FIG. 3, the voltage of the first sub-pixel electrode 191a is relatively high so that the liquid crystal molecules 31 of the first sub-regions D1a to D4a are inclined more than those of the second sub-regions D1b to D4b.

Consequently, the two sub-pixels PXa and PXb have luminances which are different from each other, and the sum of luminance thereof becomes the luminance of the whole pixel PX. For this reason, the voltages applied to the two sub-pixel electrodes 191a and 191b should be established so as to make the luminance of the pixel PX have a target value. That is, the voltages applied to the two sub-pixel electrodes 191a and 191b are diverged from the image signal with respect to one pixel PX.

When the voltages of the first and second sub-pixel electrodes 191a and 191b are appropriately controlled, the image viewed from the lateral side approximates the image viewed from the frontal side as much as possible, thereby enhancing the lateral visibility.

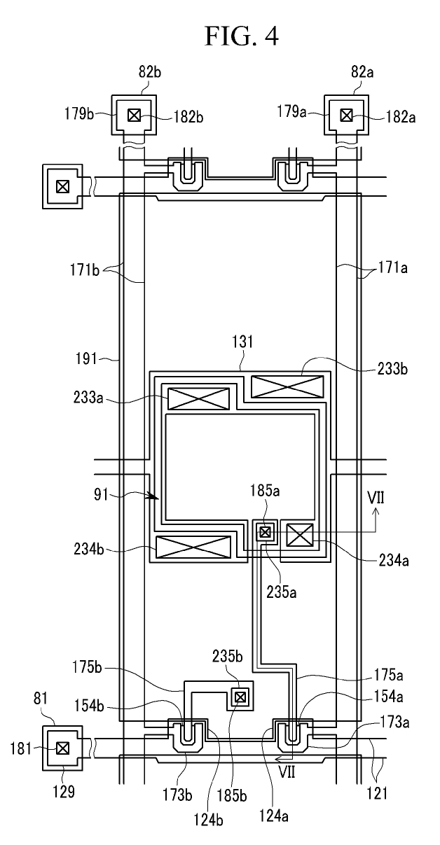

A liquid crystal display according to another exemplary embodiment will now be described in detail with reference to FIG. 4 to FIG. 7.

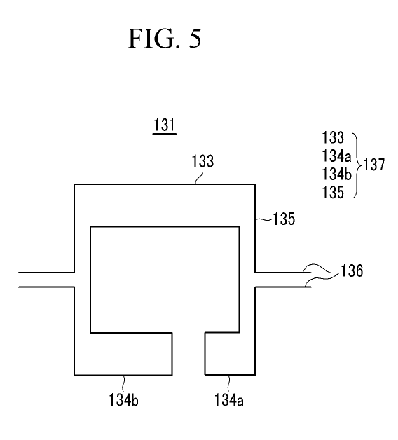

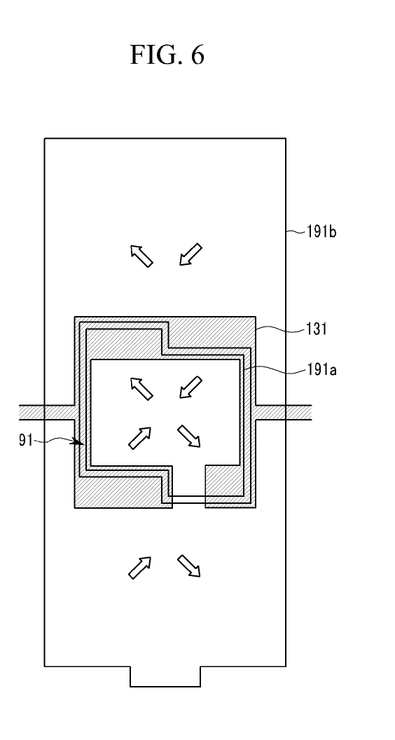

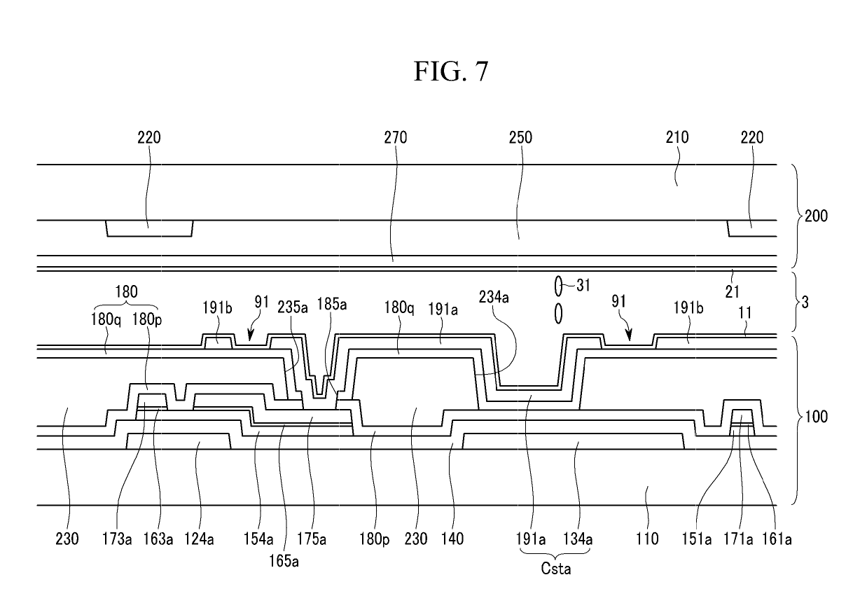

FIG. 4 is a layout view of a liquid crystal display according to an exemplary embodiment, and FIG. 5 is a layout view of a storage electrode line of the liquid crystal display shown in FIG. 4. FIG. 6 is a layout view illustrating the directions the aligned liquid crystal molecules are oriented over different regions of a pixel electrode of the liquid crystal display shown in FIG. 4, and FIG. 7 is a cross-sectional view of the liquid crystal display shown in FIG. 4 taken along the VII-VII line thereof.

Referring to FIG. 4 to FIG. 7, the liquid crystal display according to the present exemplary embodiment includes a lower display panel or a thin film transistor array panel 100, an upper display panel or a common electrode panel 200, and a liquid crystal layer 3.

First, the thin film transistor array panel 100 will be described in detail.

Gate conductors including gate lines 121 and storage electrode lines 131 are formed on an insulation substrate 110.

The gate lines 121 proceed mainly in the horizontal direction, and each includes first and second gate electrodes 124a and 124b, which protrude upward from the gate line, and a wide end portion 129.

The storage electrode lines 131 also proceed mainly in the horizontal direction, and each is interposed between two gate lines 121.

Referring to FIG. 5, the storage electrode line 131 includes a storage electrode 137 formed in the shape of an opened quadrangular band, and connectors 136 connected thereto. The storage electrode 137 includes horizontal electrode portions 133, 134a, and 134b and vertical electrode portions 135. The horizontal electrode portions 133, 134a, and 134b of the storage electrode 137 are larger in width than the vertical electrode portions 135 thereof. The horizontal electrode portions 133, 134a, and 134b include an upper electrode portion 133, a right lower electrode portion 134a, and a left lower electrode portion 134b. One end of the upper electrode portion 133 and one end of the right lower electrode portion 134a are connected to each other via one of the vertical electrode portions 135, and the opposite end of the upper electrode portion 133 and one end of the left lower electrode portion 134b are connected to each other via the other vertical electrode portion 135. The opposite ends of the right lower electrode 134a and the left lower electrode 134b are spaced apart from each other by a distance so as to form the shape of an opened quadrangle. The connectors 136 are connected to approximately the centers of the vertical electrode portions 135.

A gate insulating layer 140 is formed on the gate conductors 121 and 131.

Referring to FIG. 7, first and second semiconductor stripes 151a and 151b are formed on the gate insulating layer 140 (second semiconductor stripe 151b is not shown in the drawings). The first and second semiconductor stripes 151a and 151b proceed mainly in the vertical direction, and include first and second protrusions 154a and 154b (shown in FIG. 4) that protrude toward the first and second gate electrodes 124a and 124b.

A first ohmic contact stripe 161a and a first ohmic contact island 165a are formed on the first semiconductor stripe 151a. The first ohmic contact stripe 161a has a protrusion 163a, and the protrusion 163a and the first ohmic contact island 165a face each other over the first protrusion 154a as a pair.

A second ohmic contact stripe (not shown) and a second ohmic contact island (not shown) are formed on the second semiconductor stripe 151b. The second ohmic contact stripe also has a protrusion (not shown), and the protrusion and the second ohmic contact island face each other over the second protrusion 154b as a pair.

A first data line 171a is formed on the first ohmic contact stripe 161a, and a first drain electrode 175a is formed on the first ohmic contact island 165a. A second data line 171b is formed on the second ohmic contact stripe, and a second drain electrode 175b is formed on the second ohmic contact island (shown in FIG. 4).

Referring again to FIG. 4, the first and second data lines 171a and 171b proceed mainly in the vertical direction, and cross the gate lines 121 and the connectors 136 (FIG. 5) of the storage electrode lines 131. The first and second data lines 171a and 171b include first and second source electrodes 173a and 173b, which extend toward the first and second gate electrodes 124a and 124b, and wide end portions 179a and 179b.

The first and second drain electrodes 175a and 175b each have one end placed over the first and second gate electrodes 124a and 124b while being partially surrounded by bent portions of the first and second source electrodes 173a and 173b, and extensions that extend upward from each one end thereof, respectively. The first ohmic contacts 161a and 165a exist only between the underlying first semiconductor 151a and the overlying first data line 171a and first drain electrode 175a, so as to lower the contact resistance therebetween. The second ohmic contact exists only between the underlying second semiconductor 151b and the overlying second data line 171b and second drain electrode 175b, so as to lower the contact resistance therebetween. The first semiconductor stripe 151a has substantially the same planar shape as the first data line 171a, the first drain electrode 175a, and the first ohmic contacts 161a and 165a. The second semiconductor stripe 151b has substantially the same planar shape as the second data line 171b, the second drain electrode 175b, and the second ohmic contact. However, the semiconductors 151a and 151b both have exposed portions that are not covered by the data lines 171a and 171b and the drain electrodes 175a and 175b, including exposed portions thereof which are between the source electrodes 173a and 173b and the drain electrodes 175a and 175b.

A passivation layer 180 is formed on the first and second data lines 171a and 171b, the first and second drain electrodes 175a and 175b, and the exposed portions of the semiconductors 151a and 154b. The passivation layer 180, which includes lower and upper layers 180p and 180q, is based on an inorganic insulating material, such as silicon nitride and silicon oxide. At least one of the lower and upper layers 180p and 180q may be omitted.

The passivation layer 180 has contact holes 182a and 182b exposing the end portions 179a and 179b of the data lines 171a and 171b, and contact holes 185a and 185b exposing the wide end portions of the drain electrodes 175a and 175b. The passivation layer 180 and the gate insulating layer 140 have a plurality of contact holes 181 in common that expose the end portions 129 of the gate lines 121.

A color filter 230 is formed between the lower and upper layers 180p and 180q.

The color filter 230 has through holes 235a and 235b corresponding to the contact holes 185a and 185b of the passivation layer 180, and the through holes 235a and 235b are larger in size than the contact holes 185a and 185b of the passivation layer 180. The color filter 230 further has a plurality of openings 233a, 233b, 234a, and 234b over the storage electrodes 137. The openings 233a and 233b of the color filter 230 are formed over the upper electrode portion 133, and the openings 234a and 234b of the color filter 230 are formed over the right lower electrode 134a and the left lower electrode 134b, respectively.

Pixel electrodes 191 and a plurality of contact assistants 81, 82a, and 82b are formed on the upper layer 180q of the passivation layer 180.

As shown in FIG. 4, the pixel electrode 191 according to the present exemplary embodiment has substantially the same shape as that shown in FIG. 2. That is, the pixel electrode 191 includes first and second sub-pixel electrodes 191a and 191b spaced apart from each other with a gap 91 therebetween.

The gap 91 between the first and second sub-pixel electrodes 191a and 191b is overlapped with the storage electrode 137. The storage electrode 137 prevents leakage of light between the first and second sub-pixel electrodes 191a and 191b, and simultaneously prevents texture that may be generated due to photo-alignment. In this case, the texture may exist on a portion the liquid crystal molecules meet each other between neighboring domains or in an edge of the pixel electrode. Also, the texture may be a portion displayed in black color when a voltage is applied.

The texture induced by photo-alignment is generated around the gap 91 in the orientation direction of the liquid crystal molecules. For example, as shown in FIG. 6, texture generation may occur at the left upper and right lower portions of the first sub-pixel electrode 191a, and the right upper and left upper portions of the second sub-pixel electrode 191b. Accordingly, when the left half of the first sub-pixel electrode 191a is oriented upward and the right half thereof is oriented downward, the texture-generating regions of the first sub-pixel electrode 191a linearly coincide with those of the second sub-pixel electrode 191b. Therefore, the texture-generating regions can be effectively covered only with a storage electrode 137 having a simplified and small-area structure.

The pixel electrode 191 is also overlapped with the storage electrode 137 so as to form a storage capacitor. That is, the first sub-pixel electrode 191a is overlapped with the upper electrode portion 133 and the right lower electrode portion 134a so as to form a storage capacitor Csta, and the second sub-pixel electrode 191b is overlapped with the upper electrode portion 133 and the left lower electrode 134a so as to form a storage capacitor Cstb. Because the pixel electrode 191 and the storage electrode 137 are overlapped with each other and have only the passivation layer 180 interposed between them, the capacitance of the storage capacitor is increased.

The first and second gate electrodes 124a and 124b, the first and second protrusions 154a and 154b of the first and second semiconductor stripes 151a and 151b, the first and second source electrodes 173a and 173b, and the first and second drain electrodes 175a and 175b form first and second thin film transistors Qa and Qb, and the first and second drain electrodes 175a and 175b are connected to the first and second sub-pixel electrodes 191a and 191b through the contact holes 185a and 185b.

The contact assistants 81, 82a, and 82b are connected to the end portion 129 of the gate line 121 and the end portions 179a and 179b of the data lines 171a and 179b through the contact holes 181, 182a, and 182b, respectively. The contact assistants 81, 82a, and 82b serve to assist the adhesion of the end portion 129 of the gate line 121 and the end portions 179a and 179b of the data lines 171a and 171b to an external device such as a driver IC, and protect them.

The common electrode panel 200 will now be described in detail.

A plurality of light blocking members 220 are formed on an insulation substrate 210, and a planarization layer 250 is formed on the light blocking members 220. A common electrode 270 is formed on the planarization layer 250.

Alignment layers 11 and 21 are formed on the surfaces of the thin film transistor array panel 100 and the common electrode panel 200 facing each other, respectively.

The alignment layers 11 and 21 according to an exemplary embodiment will now be described in detail with reference to FIG. 7 to FIG. 10.

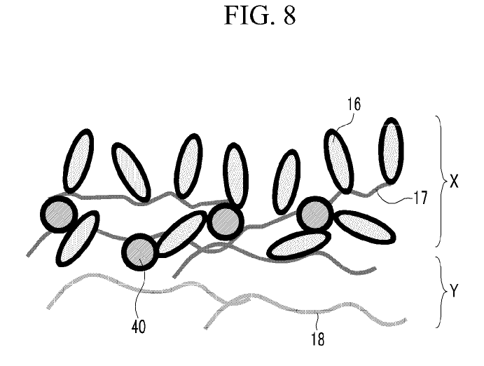

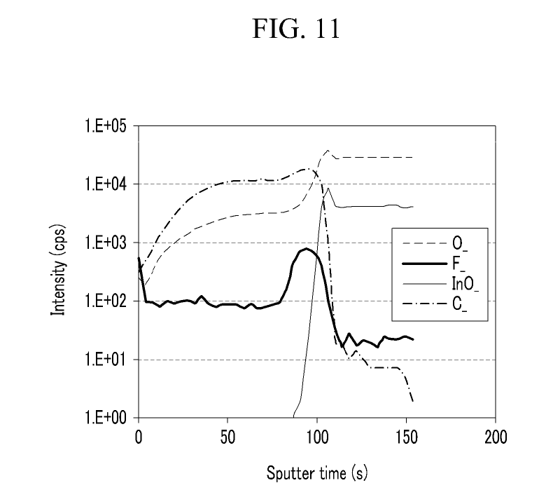

FIG. 8 is a conceptual view of an alignment layer according to an exemplary embodiment of the present invention, and FIG. 11 is a graph illustrating results of an analysis of an alignment layer according to an exemplary embodiment by using the technique of time of flight secondary ion mass spectrometry (TOF-SIMS).

The alignment layers 11 and 21 are formed with a mixture of a vertical photo-alignment material X containing a vertical functional group in the side chain thereof, and a major alignment material Y generally used in the vertical alignment (VA) mode or the twisted nematic mode. The vertical photo-alignment material X and the major alignment material Y are put in a micro-phase separation (MPS) state.

The micro-phase separation of the alignment layers 11 and 21 is a structure generated when a mixture of the vertical photo-alignment material X and the major alignment material Y is applied to the pixel 191 and the common electrode 270, and hardened. The alignment layers 11 and 21 with the micro-phase separation structure are irradiated with ultraviolet rays, and as a result, alignment layers 11 and 21 are formed by way of the reaction of a photo-reactive group. Irradiating the alignment layer 11 and 21 with ultraviolet rays generates very few side products in the alignment layers 11 and 21, and the afterimages of the liquid crystal display are reduced. Furthermore, using ultraviolet irradiation to form the alignment layers 11 and 21 without performing a separate rubbing process reduces the production cost and increases the production speed.

The vertical photo-alignment material X is mainly formed on the side of the alignment layer surface that is closer to the liquid crystal layer 3, and the major alignment material Y is mainly formed closer to the substrates 110 and 210. Accordingly, the ratio of the molar concentrations of the vertical photo-alignment material X to the major alignment material Y is increased toward the surface of the alignment layers 11 and 21 that are closer to the liquid crystal layer 3. The vertical functional group contained in the vertical photo-alignment material X may be present from the surface of the alignment layer to a depth of the alignment layer corresponding to roughly 20% of the entire thickness thereof, and in this case, the micro-phase separation structure that is formed may be relatively well-defined.

The vertical photo-alignment material X is a polymer material with a weight average molecular weight of roughly 1000 to 1,000,000, and is a compound having a main chain 17 (FIG. 8) bonded with at least one side chain. The side chain includes (i) a flexible functional group, (ii) a thermoplastic functional group, (iii) a photo-reactive group 16, and (iv) a vertical functional group, and may contain additional side chain groups. The main chain 17 may include at least one material including, but not limited to, polyimide, polyamic acid, polyamide, polyamicimide, polyester, polyethylene, polyurethane, polystyrene, etc. As the main chain 17 increasingly contains a cyclic structure, such as an imide group, the rigidity of the main chain becomes further reinforced. Accordingly, spots on the liquid crystal display that can be generated when the liquid crystal display is operated for a long period of time are reduced, and the stability with respect to the pre-tilt angle of the alignment layer is reinforced. Furthermore, if the main chain contains an imide group at a concentration of about 75 mol % or more, the spots are further reduced, and the stability with respect to the pre-tilt angle of the alignment layer is further reinforced. The pre-tilt angle is typically about 90 to 100 degrees.

The flexible functional group and/or the thermoplastic functional group can serve as functional groups that ease alignment of the side chains that are bonded to the main chain 17. The flexible functional group and the thermoplastic functional group may contain a substituted or non-substituted alkyl or alkoxy group with a carbon number of roughly 3 to 20.

The photo-reactive group 16 is a functional group that directly causes a photo-dimerization reaction or a photo-isomerization reaction upon irradiation of the photo-alignment material X with ultraviolet rays. For example, the photo-reactive group 16 may contain, but is not limited to, at least one compound selected from an azo-based compound, a cinnamate-based compound, a chalcone-based compound, a coumarin-based compound, a maleimide-based compound, etc.

The vertical functional group is a functional group that moves the entire side chain in the vertical direction, i.e. approximately perpendicular to the direction of the main chain 17, which is typically approximately parallel to the substrates 110 and 220. The vertical functional group may contain an alkyl or alkoxy group-substituted aryl group with a carbon number of 3 to 10, or an alkyl or alkoxy group-substituted cyclohexyl group with a carbon number of 3 to 10.

The vertical photo-alignment material X may be prepared by polymerizing a monomer such as a diamine bonded with a side chain such as a flexible functional group, a photo-reactive group, and a vertical functional group with acid anhydride. Furthermore, the vertical photo-alignment material X may be prepared by adding a compound bonded with a thermoplastic functional group, a photo-reactive group, or a vertical functional group to a polyimide or polyamic acid. In this case, as the thermoplastic functional group is directly bonded to the polymer main chain, the side chain contains the thermoplastic functional group, photo-reactive group, vertical functional group, etc.

The major alignment material Y contains the main chain 18, and has a weight average molecular weight thereof of about 10,000 to 1,000,000. Main chain 18 may include at least one material including, but not limited to, polyimide, polyamic acid, polyamide, polyamicimide, polyester, polyethylene, polyurethane, polystyrene, etc. When the major alignment material Y contains the imide group at a concentration of about 50 to 80 mol %, spots and afterimages of the liquid crystal display are further reduced. The major alignment material Y may contain a vertical functional group as a side chain bonded to the polymer main chain at a concentration of about 5 mol %.

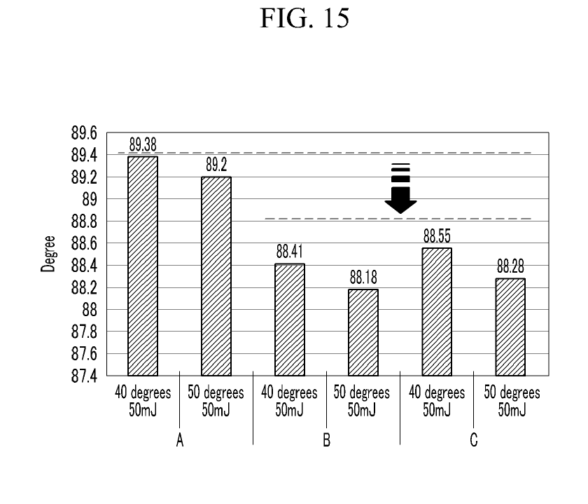

FIG. 14 is a graph illustrating the degree of afterimages in a liquid crystal display as a function of the mol % of the vertical functional group contained in the major alignment material Y. As shown in FIG. 14, when the major alignment material Y contains the vertical functional group at a concentration of about 5 mol % or less, the afterimages of the liquid crystal display are reduced. Furthermore, when the major alignment material Y contains the vertical functional group at a concentration of about 2 mol % or less, the afterimages of the liquid crystal display are further reduced.

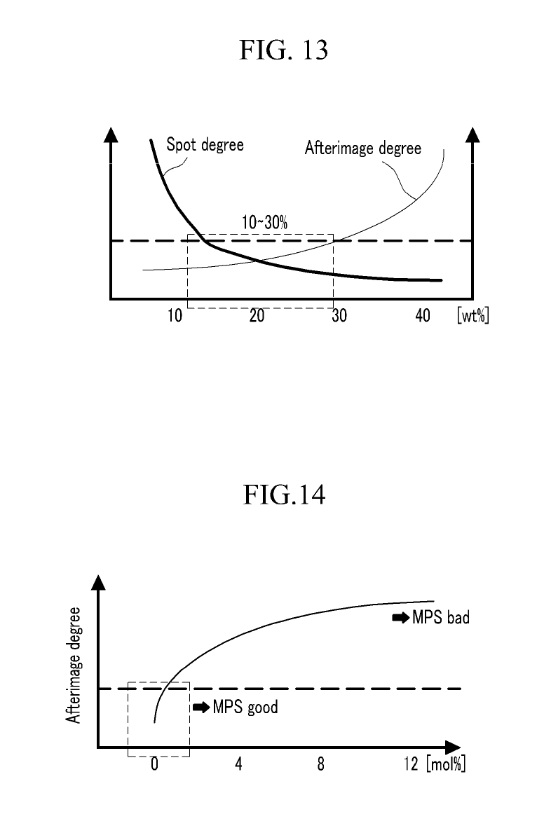

The weight ratio of the vertical photo-alignment material X to the major alignment material Y in the mixture may be in the range of about 5:95 to 50:50. If the content of the vertical photo-alignment material X in the mixture is about 50 wt % or less, the voltage holding rate (VHR) increases so that the afterimages of the liquid crystal display can be reduced. If the content of the vertical photo-alignment material X in the mixture is about 5 wt % or more, the pre-tilt angle uniformity is maintained so that spots on the liquid crystal display are reduced. FIG. 13 is a graph illustrating the degree of afterimage and spots as a function of the weight percent (wt %) of the vertical photo-alignment material X, and the graph shows that when the content of the vertical photo-alignment material X in the mixture is about 10 to 30 wt %, the afterimage and spots on the liquid crystal display are further reduced. Furthermore, as the content of the vertical photo-alignment material X in the mixture becomes smaller, the amount of photo-reactive group is reduced, and thus even fewer unwanted byproducts are generated when the vertical photo-alignment material X is irradiated with ultraviolet rays. Consequently, the afterimages of the liquid crystal display are reduced and the reaction efficiency is heightened. As the content of the vertical photo-alignment material X in the mixture is reduced, the production cost is reduced.

The vertical photo-alignment material X and the major alignment material 18 each have surface tension of about 25-65 dyne/cm, respectively. The surface tension of the vertical photo-alignment material X is identical to, or smaller than, that of the major alignment material 18, and in such case, the micro-phase separation structure becomes well-defined.

The graph shown in FIG. 11 is produced based on the technique of TOF-SIMS, and the material composition of the target alignment layer is described below.

The vertical photo-alignment material X was formed by polymerizing a diamine where two side chains containing fluorine (F), an aryl group, and cinnamate are substituted, with acid dianhydride. In this instance, the content of the vertical photo-alignment material 17 was 20 wt %. The fluorine (F) content is used as an indicator for detecting the vertical photo-alignment material X. A polyimide that did not have a vertical functional group was used as the major alignment material Y at an amount of 80 wt %. An ITO thin film was formed on a substrate, and a mixture of the vertical photo-alignment material X and the major alignment material Y was printed on the ITO thin film. After the printed mixture was hardened, it was irradiated with linearly polarized ultraviolet rays to t form an alignment layer with a thickness of 1000 Å.

As illustrated in FIG. 11, the intensity of the fluorine (F) content in the vertical functional group was radically reduced over a very short period of time, and it turned out from the measurement that the fluorine content was no longer found above 91 Å of the total depth of the alignment layer from the surface thereof. Accordingly, it can be determined that as the vertical photo-alignment material X was formed up to a depth of 9% of the total depth of the layer from the surface of the alignment layer closest to the liquid crystal layer 3, and the major alignment material Y was formed under the vertical photo-alignment material X, the micro-phase separation structure was well-defined. Furthermore, a liquid crystal display having the alignment layers was driven, and it was shown that few linear afterimages and surface afterimages were present in the liquid crystal display having the alignment layer.

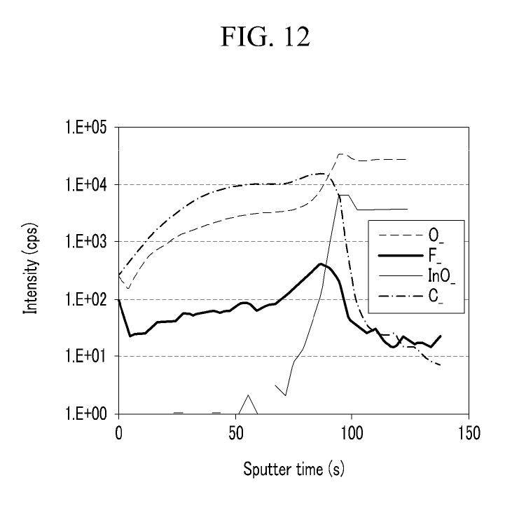

FIG. 12 is a graph illustrating the results of an analysis of an alignment layer according to an exemplary embodiment by way of the technique of TOF-SIMS. The material composition of the target alignment layer was the same as that related to FIG. 11 except that the content of the vertical photo-alignment material X was 10 wt % and the content of the major alignment material 18 was 90 wt %. In this case, the fluorine content was no longer present above 42 Å of total depth of the alignment layer from the surface thereof, and very few linear afterimages and surface afterimages were present.

Again referring to FIG. 8, a vertical photo-alignment material X according to an exemplary embodiment will be described.

The vertical photo-alignment material X according to the exemplary embodiment includes a photosensitizer 40. The photosensitizer 40 may transmit absorbed energy when UV rays are used to irradiate the photo-reactive group 16. In detail, the photosensitizer 40 may contain one of compounds having the below formulae, which can absorb a linearly polarized ultraviolet (LPUV) light source of a wavelength in the range of 200-500 μm, and then transmits the absorbed energy to the photo-reactive group 16.

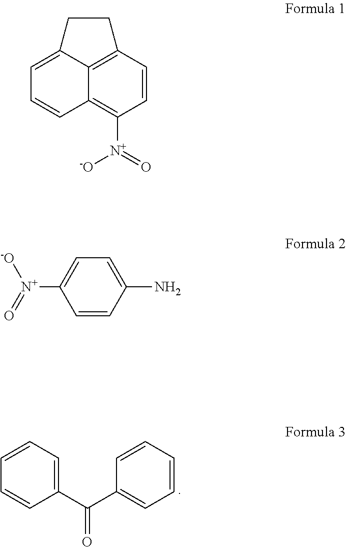

In this instance, the photosensitizer 40 does not chemically react with the main chain 17 of the vertical photo-alignment material X or the side chain including the photo-reactive group 16, and is mixed with the vertical photo-alignment material X as an additional material.

The above-described photo-reactive group 16 contains, but it not limited to, at least one compound selected from an azo-based compound, a cinnamate-based compound, a chalcone-based compound, a coumarin-based compound, a maleimide-based compound, etc. The photo-reactive group 16 according to another exemplary embodiment may contain a compound represented by Formula A below.

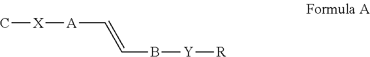

Here, A and B are independently one of cyclohexane, —CH₂—, —C₂H₄—, dioxane, tetrahydropyran, benzene, naphthalene, and chromane, X and Y are independently single bonds or —CₙH₂ₙ—, where n is an integer of 1 to 12. At least one —CH₂— among —CₙH₂ₙ— may be substituted with —O—, benzene, cyclohexane, or —C═O—. However, it is preferable that —CH₂— directly at the side of the benzene ring is not substituted with —C═O—. R may be hydrogen or an alkyl group of 1 to 12 carbon atoms, or an alkenyl group of 2 to 12 carbon atoms. Here, at least one of —CH₂— may be substituted with —O—.

C may be one of compounds represented by Formula 10 to 13 below.

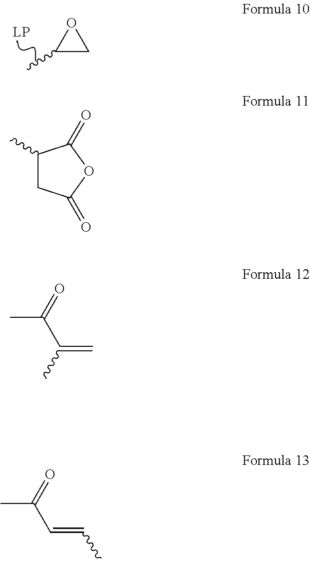

Here, the squiggly line “LP” designated in above Formula 10 is a position connected to X of Formula A. The squiggly lines in Formula 11-13 are also a position connected to X of Formula A.

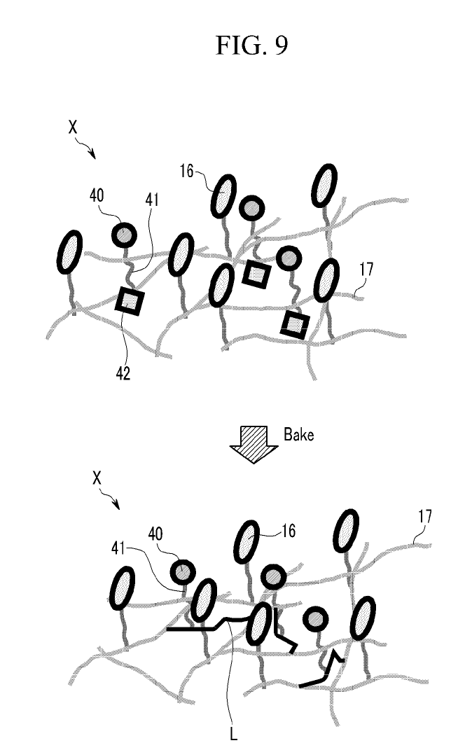

FIG. 9 is a conceptual view of an alignment layer according to another exemplary embodiment.

Referring to FIG. 9, the photosensitizer 40 is a functional group 42 that is capable of reaction with the main chain 17 of the vertical photo-alignment material X. The functional group 42 may be connected to the photosensitizer 40 by a connector 41. The functional group 42 may be one of an epoxy group, an amine group, a carboxylic acid group, and an alcohol group. For example, the photosensitizer 40 may be one of compounds represented by Formula 4 and Formula 5 below.

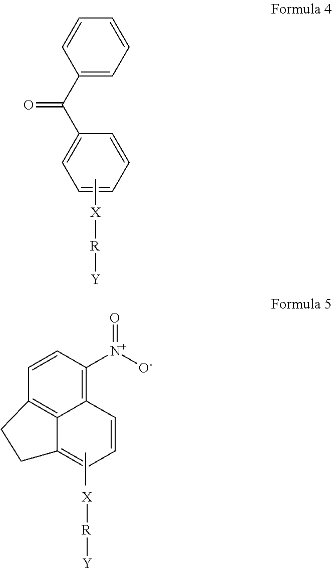

Here, X as a coupler may represent —O— or —S—, R may represent an alkyl having 1-15 carbon atoms, and Y may represent an oxirane, —OH, —NH₂, or —COOH.

The photosensitizer 40 includes the functional group 42 such that if the vertical photo-alignment material is baked, the photosensitizer 40 may be coupled to the main chain 17 or the side chain of the vertical photo-alignment material X. Here, the photosensitizer 40 may be connected to the main chain 17 through the bridge L that is separated from the connector 41. Consequently, the deterioration in which the photosensitizer 40 is lost due to a cleaning process or a baking process may be minimized. Also, the photosensitizer 40 that remains on the alignment layer, and then is eluted into to the liquid crystal layer after the manufacturing of the panel thereby functioning as the impurity, may be minimized.

The photo-reactive group 16 described through FIG. 8 may be applied to the present exemplary embodiment.

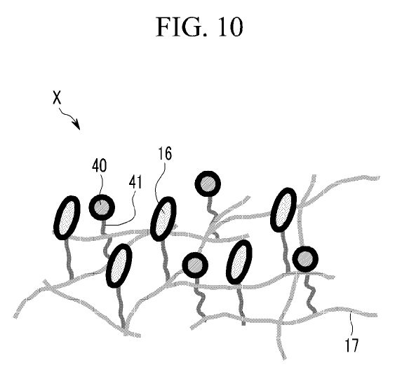

FIG. 10 is a conceptual view of an alignment layer according to another exemplary embodiment.

Referring to FIG. 10, the photosensitizer 40 is connected to the main chain 17 through the connector 41. FIG. 10 is similar to the exemplary embodiment described with reference to with FIG. 9, however there is a method difference. According to the present exemplary embodiment, a first monomer including the photosensitizer 40 and a second monomer including the photo-reactive group 16 are copolymerized, thereby forming the vertical photo-alignment material X.

For example, the first monomer may be one of compounds represented by Formula 6 and Formula 7 below.

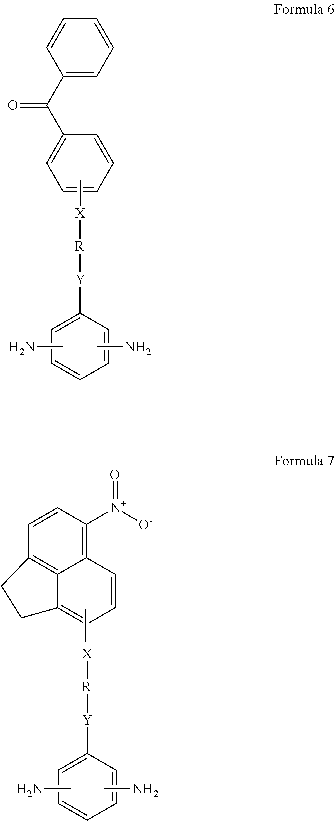

Here, X as a coupler may represent —O— or —S—, R may represent an alkyl having 1-15 carbon atoms, and Y may represent —O— or —COO—.

The first monomer including the photosensitizer 40 during the copolymerization may have a concentration ratio of 0.01 to 50.0 mol % with respect to the second monomer.

The photo-reactive group 16 described with reference to FIG. 8 may be applied to the present exemplary embodiment.

Compared with the alignment layer that includes the vertical photo-alignment material as described with reference to FIG. 9, the photosensitizer 40 in the present exemplary embodiment has a uniform concentration in the alignment layer, and is positioned close to the photo-reactive group 16 such that the energy transmitting effect into the photo-reactive group 16 may be increased. Accordingly, the photo-reaction efficiency may be increased.

FIG. 15 is a graph illustrating a pre-tilt angle as a function of the addition of a photosensitizer according to an exemplary embodiment.

Referring to FIG. 15, a sample A is a test cell manufactured with an alignment layer that does not include the photosensitizer, and samples B and C are test cells manufactured with an alignment layer including the photosensitizer. The sample B and the sample C respectively use 5-nitroacenaphthene and 4-nitroaniline as the photosensitizer. The sample B and the sample C respectively use a photo-alignment layer to which the photosensitizer is added with the content of 0.2 wt % compared with the content of the vertical photo-alignment material X and the major alignment material Y. The concentration ratio of the vertical photo-alignment material X to he major alignment material Y is 20:80. For each sample, a thin film transistor substrate and a color filter substrate were printed with an alignment layer and then were obliquely irradiated with UV light. Then, the test cells were manufactured, including inserting the liquid crystal. The UV irradiation used to irradiate the alignment layer had conditions of an inclination angle of 40 degrees and 50 mJ, and 50 degrees and 50 mJ, as noted in FIG. 15.

The results of measuring the pre-tilt angle of the test cell manufactured through each condition, confirms that the pre-tilt angle of the sample added with the photosensitizer is increased by about 0.8 degrees to 1.0 degree in both conditions compared with the sample that does not have the photosensitizer added.

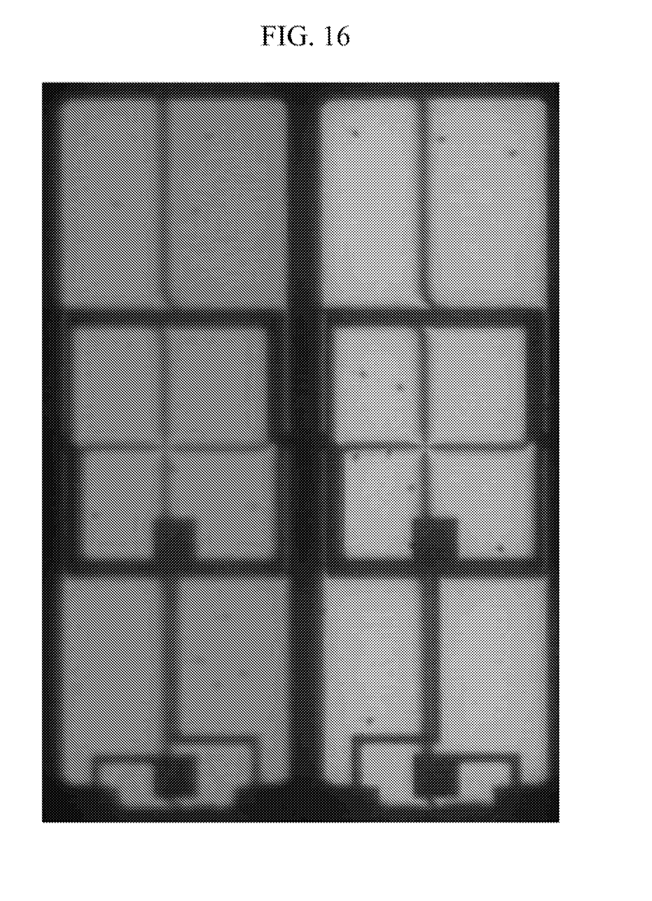

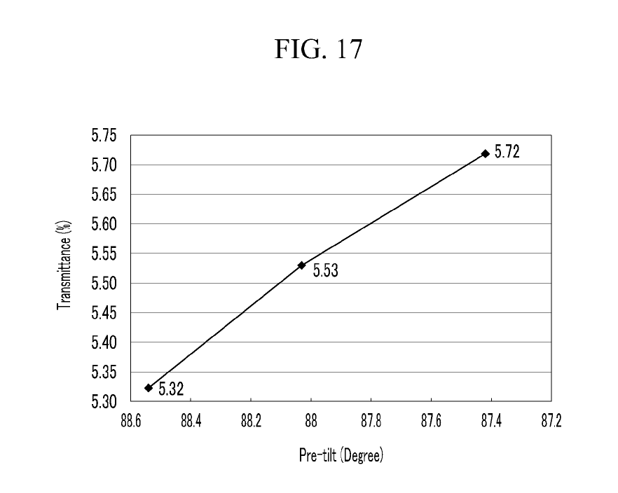

FIG. 16 is a pixel picture of a photo-aligned cell including 4-direction domains and FIG. 17 is a graph showing transmittance according to a pre-tilt angle.

Referring to FIG. 16, textures in the liquid crystal of a crossed shape are present on the domain boundaries of 4-direction domains. As the textures are increased, the transmittance is decreased. Here, as the pre-tilt angle is low, the director of the liquid crystal may be aligned in the desired direction such that the width of the textures is reduced. Accordingly, as shown in FIG. 17, as the pre-tilt angle decreases, the transmittance increases. In the liquid crystal display according to an exemplary embodiment, the pre-tilt angle is additionally formed by adding the photosensitizer described with reference to FIG. 15, as the result, the transmittance may be increased.

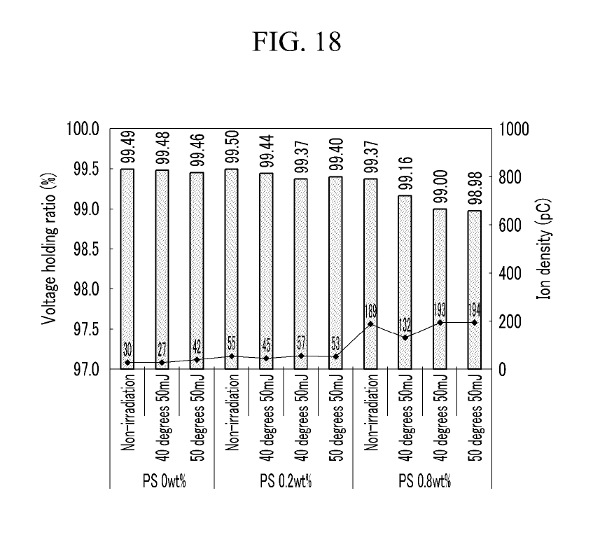

FIG. 18 is a graph showing a voltage holding ratio and ion density as a function of the content of a photosensitizer according to an exemplary embodiment.

The photosensitizer may be added with the content of 0.001 to 10 wt % compared with the content of the vertical photo-alignment material X and the major alignment material Y. Referring to FIG. 18, when the content of the photosensitizer is about 0.2 wt %, the influence on the voltage holding ratio and the ion density is small, and when the content of the photosensitizer is about 0.8 wt %, the voltage holding ratio is largely reduced and the ion density is increased. Accordingly, considering the pre-tilt angle and the electrical characteristics, the photosensitizer with the content of 0.001 to 2 wt % may be added.

Table 1 represents an estimation of a surface afterimage of a test cell of which the content of the photosensitizer is variably 0 wt %, 0.2 wt %, and 0.8 wt %.

TABLE 1

| | | Voltage at which a surface |
|---|---|---|
| | UV exposure | afterimage does not appear |
| Photosensitizer 0 | 40 degrees/ | 2.8 |
| wt % | 50 mJ | 2.8 |
| Photosensitizer 0.2 | 40 degrees/ | 2.7 |
| wt % | 50 mJ | 2.8 |
| Photosensitizer 0.8 | 40 degrees/ | 2.8 |
| wt % | 50 mJ | 2.9 |

After an electric field is applied 336 times at 50° C. to the test cell divided into four regions in the diagonal direction, and including a black region and a white region, the degree of surface afterimage is measured through the voltage at which the luminance difference between the black and white regions is not generated. The black afterimage is measured by relatively comparing the degree of luminance difference between the black and white regions.

The degree of surface afterimage in the case in which the content of the photosensitizer is increased to 0.8 wt % is also almost the same as before the addition, and it appears that the afterimage is slightly improved according to the addition of the photosensitizer in the case of the black afterimage. Accordingly, it is determined that the addition of the photosensitizer positively influences the black afterimages of the panel.

The above described photo-alignment of the alignment layer of the liquid crystal display was achieved using materials described according to an exemplary embodiment, however, the disclosure is not limited thereto.

A method of manufacturing a liquid crystal display according to an exemplary embodiment will now be described. However, overlapping descriptions will be omitted.

Thin film transistors including gate electrodes 124a and 124b, source electrodes 173a and 173b, drain electrodes 175a and 175b, and semiconductors 154a and 154b are formed on a substrate 110. Lower and upper layers 180p and 180q are formed on the thin film transistors. A color filter 230 is formed between the lower and upper layers 180p and 180q. Pixel electrodes 191a and 191b and contact assistants 81, 82a, and 82b are formed on the upper layer 180q.

A mixture of a vertical photo-alignment material X and a major alignment material Y is printed onto the pixel electrodes 191a and 191b and the contact assistants 81, 82a, and 82b by way of inkjet printing, and is hardened. The hardening may be performed in two steps. The mixture is pre-baked at about 70-80° C. for about 2 to 3 minutes to thereby remove a solvent therefrom, and is hardened at about 210° C. or more for about 10 to 20 minutes to thereby form a micro-phase separation structure. At this time, the vertical photo-alignment material X is formed at the upper side area, and the major alignment material Y is formed at the lower side area.

Thereafter, the substrate 110 is irradiated with ultraviolet rays that strike the surface in a vertical or inclined direction thereto. In this instance, as a rubbing process in a separate manner does not need to be conducted to form the alignment layer 11, the production speed is increased and the production cost is reduced. Furthermore, the direction of irradiating ultraviolet rays may be altered using a mask so that multi-domains that are differentiated in the orientation of the pre-tilt angle direction may be formed. The ultraviolet rays may be partially polarized ultraviolet rays or linearly polarized ultraviolet rays. The wavelength of the ultraviolet rays may be about 270 to 360 nm, and the energy thereof may be about 10 to 5000 mJ.

Then, a liquid crystal layer 3 is formed on the alignment layer 11.

Meanwhile, a light blocking member 220, an overcoat 250, and a common electrode 270 are sequentially formed on a substrate 210. An alignment layer 21 is formed on the common electrode 270 in the same way as that used for forming the alignment layer 11 thereon.

The substrate 210 is disposed such that the alignment layer 21 formed on the substrate 210 contacts the liquid crystal layer 3, and the two substrates 110 and 210 are combined with each other.

However, if the liquid crystal layer 3 is formed on the alignment layer 21 of the substrate 210, the substrate 210 is disposed such that the alignment layer 11 formed on the substrate 110 contacts the liquid crystal layer 3, and the two substrates 110 and 210 are combined with each other.

A common thin film deposition or photolithography-based patterning method may be used in order to form thin film transistors and electrodes.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A photo-alignment agent comprising:
a first alignment material without a photo-reactive group;
a second alignment material including a photo-reactive group; and
a photosensitizer mixed with the second alignment material.

2. The photo-alignment agent of claim 1, wherein
the photosensitizer is an additional material that does not chemically react with the second alignment material.

3. The photo-alignment agent of claim 2, wherein
the photosensitizer is one of compounds represented by Formula 1 to Formula 3:

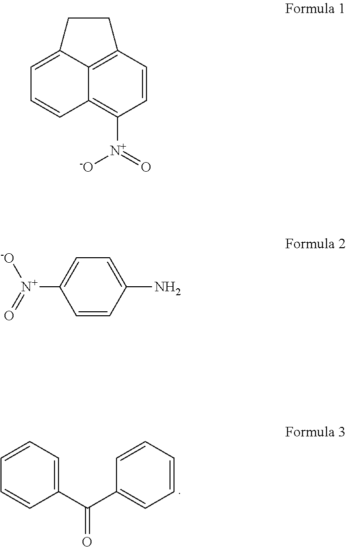

4. The photo-alignment agent of claim 1, wherein
the photosensitizer is coupled to the second alignment material after baking the second alignment material.

5. The photo-alignment agent of claim 4, wherein
the photosensitizer includes a functional group capable of reacting with the second alignment material.

6. The photo-alignment agent of claim 5, wherein
the functional group is one of an epoxy group, an amine group, a carboxylic acid group, and an alcohol group.

7. The photo-alignment agent of claim 6, wherein
the photosensitizer is one of compounds represented by Formula 4 and Formula 5: 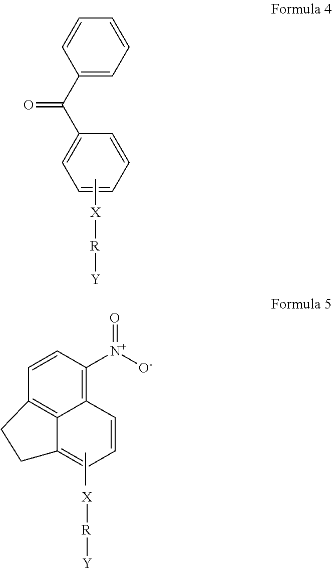
wherein X as a coupler represents —O— or —S—, R may represent an alkyl having 1-15 carbon atoms, and Y may represent an oxirane, —OH, —NH₂, or —COOH.

8. The photo-alignment agent of claim 1, wherein
a first monomer includes the photosensitizer and;
a second monomer includes the second alignment material including the photo-reactive group,
wherein the first monomer and second monomer are copolymerized to form a photo-alignment layer.

9. The photo-alignment agent of claim 8, wherein
the first monomer is one of compounds represented by Formula 6 and Formula 7: 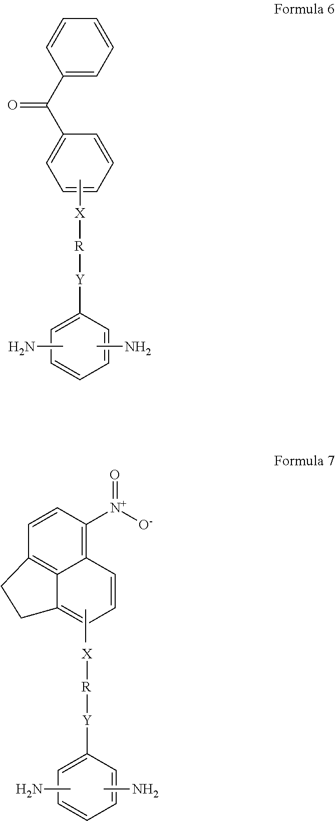
wherein X as a coupler represents —O— or —S—, R represents an alkyl having 1-15 carbon atoms, and Y represents —O— or —COO—.

10. The photo-alignment agent of claim 1, wherein
the photosensitizer absorbs a wavelength of 200-500 μm from a UV light source that is linearly polarized, thereby transmitting energy to the photo-reactive group.

11. The photo-alignment agent of claim 1, wherein
the first alignment material and the second alignment material form an alignment layer having a surface, and a ratio of a mol concentration of the second alignment material to a mol concentration of the first alignment material is increased close to the surface of the alignment layer.

12. The photo-alignment agent of claim 1, wherein
the first alignment material and the second alignment material have a weight ratio of 5:95 to 50:50.

13. The photo-alignment agent of claim 1, wherein
the second alignment material includes an imide group at a concentration of more than 75 mol %.

14. A photo-alignment agent comprising
a photo-alignment material including a main chain and a side chain having a photo-reactive group; and
a photosensitizer,
wherein the photo-reactive group includes a compound represented by Formula A: 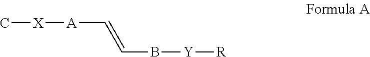
wherein A and B are independently one of cyclohexane, —CH₂—, —C₂H₄—, dioxane, tetrahydropyran, benzene, naphthalene, and chromane,
X and Y are independently single bonds or —CₙH₂ₙ—, where n is an integer of 1 to 12; and
R is hydrogen or an alkyl group with 1-12 carbon atoms.

15. The photo-alignment agent of claim 14, wherein
C in the compound represented by Formula A is one of compounds represented by Formula 10 to 13: 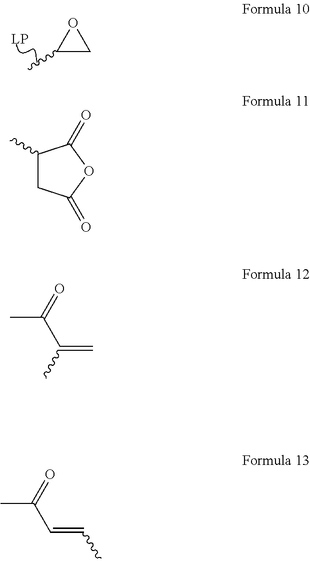
wherein LP is a position connected to X.

16. The photo-alignment agent of claim 14, wherein
the photosensitizer is an additional material that does not chemically react with the main chain or the photo-reactive group, and is one of compounds represented by Formula 1 to Formula 3:

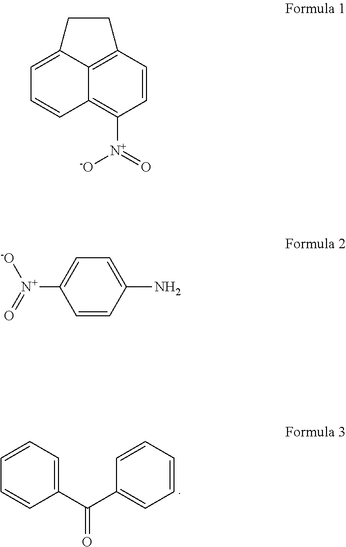

17. The photo-alignment agent of claim 14, wherein
the photosensitizer includes a functional group that is coupled with the main chain after baking the photo-alignment material, and the functional group is one of an epoxy group, an amine group, a carboxylic acid group, and an alcohol group.

18. The photo-alignment agent of claim 14, wherein
a first monomer includes the photosensitizer;
a second monomer includes the photo-reactive group,
wherein the first monomer and the second monomer are copolymerized to form a photo-alignment layer

19. A liquid crystal display comprising:
a first substrate;
a second substrate facing the first substrate;
an alignment layer formed on at least one of the first substrate and the second substrate, the alignment layer including
a first alignment material,
a second alignment material having a photo-reactive group, and
a photosensitizer mixed with the second alignment material; and
a liquid crystal layer interposed between the first substrate and the second substrate.

20. The liquid crystal display of claim 19, wherein
the photosensitizer absorbs a wavelength of 200-500 μm from a UV light source that is linearly polarized, thereby transmitting energy to the photo-reactive group.

21. The liquid crystal display of claim 20, wherein
the photo-reactive group includes a compound represented by Formula A: 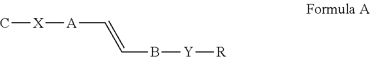
wherein A and B are independently one of cyclohexane, —CH₂—, —C₂H₄—, dioxane, tetrahydropyran, benzene, naphthalene, and chromane,
X and Y are independently single bonds or —CₙH₂ₙ—, where n is an integer of 1 to 12, and
R is hydrogen or an alkyl group with 1-12 carbon atoms.

22. The liquid crystal display of claim 19, wherein
the photosensitizer is an additional material that does not react with the second alignment material, and is one of compounds represented by Formula 1 to Formula 3:

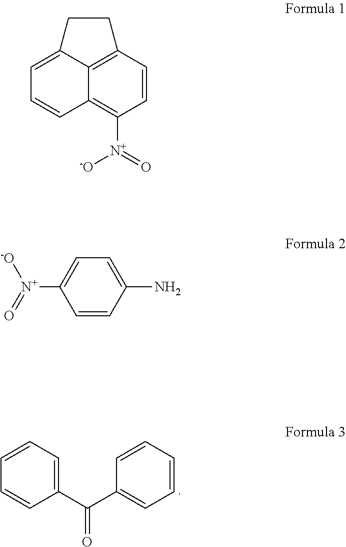

23. The liquid crystal display of claim 19, wherein
the photosensitizer includes a functional group that is coupled with the main chain after baking the second alignment material, and the functional group is one of an epoxy group, an amine group, a carboxylic acid group, and an alcohol group.

24. The liquid crystal display of claim 19, wherein
the alignment layer is formed by copolymerizing a first monomer including the photosensitizer and a second monomer including the photo-reactive group.

25. The liquid crystal display of claim 19, wherein
a ratio of a mol concentration of the second alignment material to a mol concentration of the first alignment material is increased close to the surface of the alignment layer.

26. The liquid crystal display of claim 19, further comprising:
a first signal line and a second signal line intersecting each other on the first substrate;
a thin film transistor connected to the first signal line and the second signal line;
a pixel electrode connected to the thin film transistor; and
a common electrode formed on the second substrate.

27. The liquid crystal display of claim 26, wherein
the pixel electrode includes a first sub-pixel electrode and a second sub-pixel electrode.

28. The liquid crystal display of claim 27, wherein
the second sub-pixel electrode includes:
a first electrode piece disposed, in a layout view, above the first sub-pixel electrode;
a second electrode piece disposed, in a layout view, under the first sub-pixel electrode and connected to the first sub-pixel electrode; and
a plurality of bridges connecting the first electrode piece and the second electrode on, in a layout view, right and left sides of the first sub-pixel electrode.
